(19) United States
(12) Patent Application Publication
(10) Pub. No.: US 2010/0088179 A1
(43) Pub. Date: Apr. 8, 2010

(54) SYSTEMS AND METHODS FOR PROVIDING ADVERTISEMENTS WITH DIRECTIONS

(76) Inventors: Amit V. Desai, San Francisco, CA (US); Arnold V. Lindseth, III, Berkeley, CA (US); Mariana Lopez, Alameda, CA (US); Jesus Lopez Amaro, Alameda, CA (US); Joseph J. Schmid, Silver Spring, MD (US); Adeeb W.M. Shanaa, Alameda, CA (US)

Correspondence Address: NORTH WEBER & BAUGH LLP, 2479 E. BAYSHORE ROAD, SUITE 707, PALO ALTO, CA, 94303, US

(21) Appl. No.: 12/248,003

(22) Filed: Oct. 8, 2008

(51) Int. Cl. G06Q 30/00; H04W 4/02

(52) U.S. Cl. 705/14.49; 455/456.3

(57) ABSTRACT

Systems and methods for providing dynamic on-demand directions with targeted advertisements are disclosed.

### BACKGROUND OF THE INVENTION

1. Field of the Invention

The present invention relates generally to providing dynamic on-demand directions with advertisements to users. More specifically, systems and methods for providing dynamic on-demand directions with targeted advertisements are disclosed.

2. Description of Related Art

Current advertisement technology for targeting consumers is limited. Many advertisements are provided only to broad demographic groups and thus are mostly indiscriminate. For example, traditional means of local advertising, such as newspaper, neighborhood mailings, and local television programming can only very coarsely target an audience, i.e. by demographic characteristics (e.g. readers of a particular paper; affluence of a neighborhood; viewer demographics for a particular TV show or time slot). Such media cannot provide dynamically targeted advertisements.

As another example, radio advertising can reach users while they are mobile (e.g. while driving) but is also limited to demographic targeting. Thus radio advertising cannot dynamically target advertisements by user interest and/or consumers who are at a specific location. In both cases, such traditional methods of advertising (newspaper, TV, radio) cannot dynamically reach users who are already on the go and are in close proximity to a local business.

Online advertising, and in particular targeted online advertising, is an effective method for advertisers to reach customers who are interested in the advertisers' products/services. For example, search-based advertising (and in particular keyword triggered text advertising) provided by search engines has relatively high return on investment (ROI) for advertisers and has grown very quickly. However, such methods for targeting ads can only provide ads that are, for example, related to a user's topic of interest as expressed by keywords entered in a search engine. In addition, online advertising is not generally a well suited medium for advertisers or businesses that rely on in-person (e.g., face-to-face) transactions with consumers.

Local search-based online advertising can combine online advertising (e.g., topics of interest) with a location expressed by the user (e.g., request for a map or directions). Such local advertising more readily services local advertisers, i.e. businesses/services that have a limited geographic focus. However, such targeting typically occurs when users are sitting at their computer rather than in the vicinity of the location. For example, a user may be at home searching for Mexican restaurants in a different city that the user may wish to patronize hours or even days later. Therefore ads are presented in a time frame different from when users will be in the location of interest, and are thus less temporally relevant. In addition, such ads are not able to generate nor allow advertisers to capitalize on spur of the moment interest and spending.

Thus although local search-based advertising allows advertisers to target consumers based on a topic of interest (i.e. keywords in the search query as specified by consumer) and location, it does not target consumers at the right time—when they are out and already on the go and when they are more likely able to go to a brick and mortar store to transact.

Thus it would be desirable to provide systems and methods for provide advertisements that are dynamic, better targeted, and thus more effective.

### SUMMARY OF THE INVENTION

Systems and methods for providing dynamic on-demand directions with targeted advertisements are disclosed. It should be appreciated that the present invention can be implemented in numerous ways, including as a process, an apparatus, a system, a device, a method, a computer readable medium such as a computer readable storage medium, or a computer network wherein program instructions are sent over optical or electronic communication lines.

These and other features and advantages of the present invention will be presented in more detail in the following detailed description and the accompanying figures which illustrate by way of example principles of the invention.

### BRIEF DESCRIPTION OF THE DRAWINGS

The present invention will be readily understood by the following detailed description in conjunction with the accompanying drawings, wherein like reference numerals designate like structural elements.

FIG. 1 is a flowchart illustrating an exemplary process for providing dynamic on-demand directions with targeted advertisements to users.

FIG. 2 is a block diagram of an exemplary framework employing dynamic on-demand directions with targeted advertisements system and service.

### DESCRIPTION OF SPECIFIC EMBODIMENTS

Systems and methods for providing dynamic on-demand directions with targeted advertisements are disclosed. The following description is presented to enable any person skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein. For purpose of clarity, details relating to technical material that is known in the technical fields related to the invention have not been described in detail so as not to unnecessarily obscure the present invention.

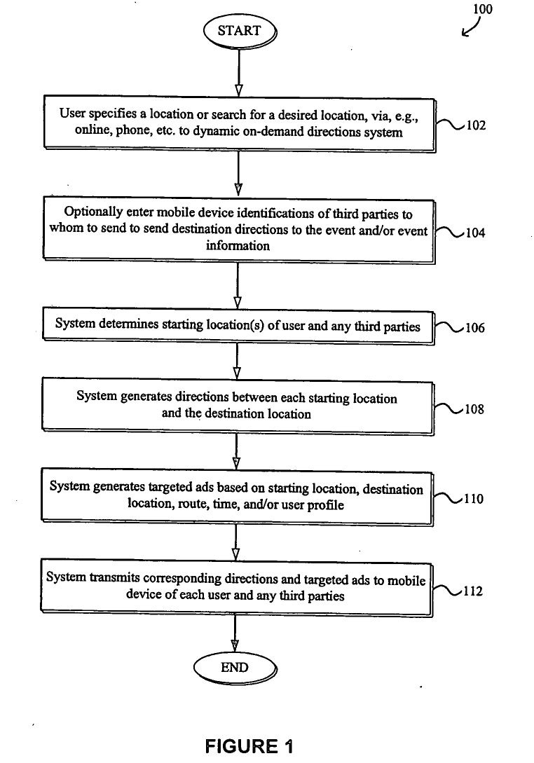

FIG. 1 is a flowchart of an exemplary process 100 for providing dynamic on-demand directions with targeted advertising to users. The dynamic on-demand directions generation process 100 allows a user to specify a destination location and to obtain dynamically generated directions to the destination location on-demand along with targeted advertisements. In particular, at block 102, the user may specify a location or a search for a desired location such as a search for stores, product or service. Examples of the search for a desired location may be a search for a specific store, a category of products/services, landmark (such as shopping malls, stadiums, bridges), or event (such as a concert, sports game, convention). The user may specify the location or the desired search for a location via, for example, online, mobile phone, etc. to the dynamic on-demand directions and targeted ads system.

The user may use a mobile device to enter the location or the desired search for a location. For example, the system may be configured for voice entry and the user may use a mobile phone to call into the voice entry system. As an example, the system may be accessed by calling a mnemonic using a full 10-digit non-toll free number such as 1-DIRECTIONS (1-347-328-4667). Because many mobile phone services do not have toll charges, such a mnemonic non-toll free number is particular suited for mobile phone users.

Next, at block 104, the user may optionally enter mobile device identifications of third parties to whom to send to send destination directions to the event and/or event information. This allows the directions and ad system to also be utilized in planning meetings where a user invites other people to meet at a location.

At block 106, the system then determines the starting location(s) of the user and any third parties. For example, the system may have stored one or more starting locations associated with each user and/or mobile device identification. Each user and third party may select from the corresponding stored starting locations and/or specify a different starting location. As another example, where the mobile device is a GPS device or has other location-based service (LBS) capabilities (e.g. using cell-tower triangulation or other techniques, e.g. those associated with E-911 requirements), the GPS or LBS-enabled device may be used to automatically provide the current location to the system. At block 108, the system generates directions between each specified starting location and the destination location.

At block 110, the system generates targeted ads based on the starting location, the destination location, route, time, and/or user profile. The time used for targeting may be any one or more of several relevant times, e.g. the time of the request for directions, the time of an event specified by a user in a search for the desired location, the time specified for a meeting or event, a time specified directly or indirectly by the user, a time inferred from a user's profile or usage pattern, etc. etc.. The generation of targeted ads at block 110 will be described in more detail below.

At block 112, the system transmits directions and targeted ads to the mobile device of the corresponding user or third party. For example, where the user calls the system to request directions, audio ads can be provided in the call, e.g., one or more ads after the caller has provided the necessary information to generate directions but before the call is terminated. The audio ads may be provided before or after the directions are given in the call. One or more of the ads may also contain directions to the advertiser's location. For example, the audio ad may state “For directions to the Starbucks closest to the destination location, press or say 1. For directions to the Starbucks closest to the starting location, press or say 2.”

As another example, text ads may be delivered to the user's (or third party's) mobile device such as a mobile phone via one or more short message services (SMS), multimedia message services (MMS), or other techniques. One or more ads can be provided together with directions in an SMS/MMS. Alternatively or additionally, one or more ads can be delivered in one or more separate SMS/MMS's separated from the directions.

Advertisements can contain coupons (including e.g. coupon codes, bar codes delivered in image form, etc.), or one-time or limited-time promotional offers that are suited to the delivery media. For example, the message may state “Today only! An extra 30% of your purchases at Macy's Men's Department” and that incentivize users and/or third parties to visit the service/product provider while they are in the vicinity. One benefit of such advertising is that the advertiser can better or more easily monitor the effectiveness of ads and to recognize people who come to the advertiser through this channel, e.g., by correlating the delivery of ads (based on the customer's profiles, mobile number, etc.) with their transaction, e.g., if the customer takes advantage of a coupon or offer sent to them or if the customer chooses to give the advertiser their cell phone number (or other mobile device identification). To better ensure that only the recipient uses the coupon or offer, the advertiser may require a match between a coupon/promotion code and a specific user's mobile number.

The generation of targeted ads at block 110 will now be described in more detail. In the case where the user specifies a starting location and a destination location for directions, because the directions and targeted ad system provides the routing information, i.e., directions, the system can deliver ads by businesses that are generally located en route. In addition, certain additional information may also be derived from the start and/or destination locations for use in targeted advertising. For example, popular locales, events, and/or businesses in the area, and demographics such as income or habits of those people associated with the areas may be derived from the start and/or destination locations.

Furthermore, because the system and service may be able to identify users (e.g., using caller ID based on cell phone numbers or other mobile device identifications), use profile or prior behavior information may be collected, stored and used to target users. As an example, if the user has previously searched for Starbucks, the system may target an ad for a Starbucks along the way, near the start location, and/or near the destination location. As yet another example, information on recent searches for high end stores or services such as high end electronics or furniture stores may be used to target ads for similar stores or services. Based on the identification of the user and/or the user profile, the system may also determine if the user is local to the area or a visitor and target advertisements appropriate for such different profiles. A preset threshold may be used to determine whether the user is local or a visitor, e.g., by distance, by zip code, by area code, or by crossing county or state lines, for example, between the starting/destination locations and the user's address (e.g., in the user's profile). For example, the service may target ads for tourist destinations and/or other well known visitor sites for visitors and eclectic places for locals.

Where the user specifies a search for a desired location instead of the location itself, in addition to the targeting criteria used above, additional information such as user interest and/or the (or one of the) motivations behind the directions request may be derived and utilized to target ads. As an example, if the user is requesting directions to a local shopping mall, ads from merchants in the mall can be targeted for the user. If the user requests a search for a nearby “hardware store” or “Home Depot” and directions thereto, ads from merchants in the same or similar category may be targeted for the user.

Where the user enters the mobile device identifications of third parties, e.g., to invite third parties for purposes of meeting planning, targeting criteria can further be derived based on the host, the meeting location, type of meeting, the any available profiles of the invited third parties, and/or other information the host may have provided. For example, where the meeting is for a party, the system may target ads from merchants near the guest's starting location, near the destination (party) location, or en route, for merchandise that guests may be interested in bringing to a party.

Note that such ad targeting is well suited for short-duration, while-you-are-there, since-you-happen-to-be-in-the-area advertisement and promotions. It is suited for mobile users and the immediacy (i.e., temporal proximity) allows ads to be targeted to users not only while they are on the road but also when the user is or will be physically near the advertiser. The targeting system and service also allows identification of users and/or profiles to be generated for users. For example, the targeting system may use mobile device identifications (e.g., mobile phone numbers). Given that users often keep a mobile phone number for a relatively long period of time, such numbers are easy to remember and are generally uniquely identified with users, and recent mobile phone number portability, profiles (including activity over extended periods of time) can be created for users using such numbers.

For businesses that depend on face-to-face transactions (such as local service-oriented businesses, retail, and restaurant businesses), the current system enables targeted advertising that:
target consumers who are likely to be interested in the product or service (e.g., based on the destination location, user profiles, destination search, etc.),
qualify those consumers who are likely to purchase the product or service (e.g., based on user profiles including demographic information and/or prior behavior or requests, any meeting information, and/or correlation between the current day/time and the merchant hours), and
target those consumers with the ad right when (or just before) they are in the immediate vicinity (e.g., based on starting or destination locations and/or the route there between).

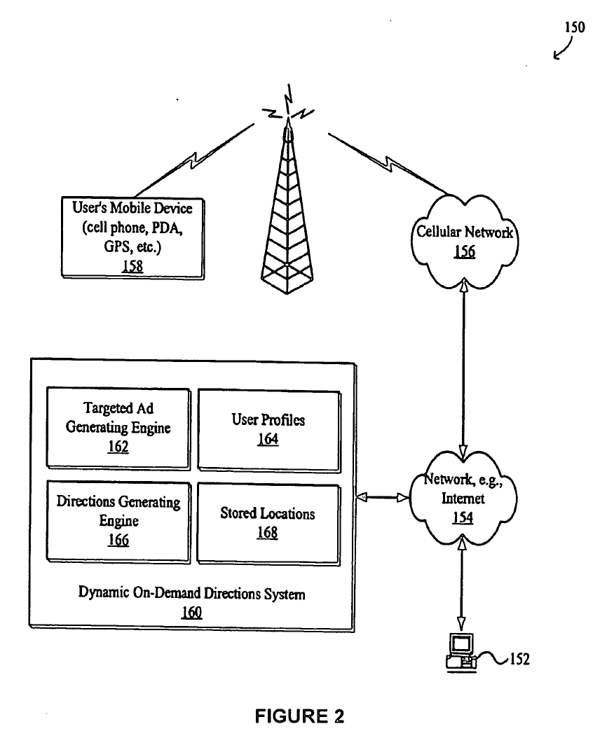

FIG. 2 is a block diagram illustrating an exemplary framework 150 employing dynamic on-demand directions with targeted advertisements system and service 160. As shown, the framework 150 may generally include a device such as a personal computer 152 in communication with a dynamic on-demand directions system 160 via a network such as the Internet 154. The directions system 160 may in turn be in communication with a user's mobile device 158 via the Internet 154 and a cellular network 156. The user may use the personal computer 152 to specify destination locations to the directions system 160 via the Internet 154.

The directions system 160 may generally include a targeted ad generating engine 162, a database of user profiles 164, a directions generating engine 166, and a database of stored locations 168. The targeted ad generating engine 162 may generate targeted ads based the targeting criteria as generally described above and may use a corresponding user profile stored in the database of user profiles 164. Each user profile 164 may correspond to one or more mobile device identifications (e.g., cell phone number, GPS device identification, etc.) and the user's demographics and usage history (e.g., prior requests for directions). The directions generating engine 166 may generate directions based on the starting and destination locations. The database of stored locations 168 may include various stored destination locations and/or tokens and optionally starting locations for various users. Each user may choose to store some commonly used starting and/or destination locations (e.g., office, school, and home locations) to facilitate the use of the directions system.

While the exemplary embodiments of the present invention are described and illustrated herein, it will be appreciated that they are merely illustrative and that modifications can be made to these embodiments without departing from the spirit and scope of the invention. Thus, the scope of the invention is intended to be defined only in terms of the following claims as may be amended, with each claim being expressly incorporated into this Description of Specific Embodiments as an embodiment of the invention.

What is claimed is:

1. A method for providing directions with targeted advertising, comprising:
determining a destination location based on a user request for directions;
determining a starting location based on the user request for directions;
generating directions between the starting and destination locations;
generating at least one targeted advertisement based on at least one of the starting location, the destination location, the directions, a time associated with the directions, and/or a user profile associated with a user; and
transmitting the directions and the at least one targeted advertisement to a user remote mobile device.

2. The method of claim 1, further comprising:
receiving information for at least one third party invitee to whom to transmit destination directions to a meeting and determining a start location associated with the third party invitee, wherein the generating directions includes generating direction between the start location for the third party invitee and destination location, and wherein the generating the at least one targeted advertisement includes generating based on at least one of starting location of the third party invitee, the destination location, the directions for the third party invitee, the time associated with the directions, and/or a user profile associated with each third party invitee.

3. The method of claim 2, wherein the generating at least one targeted advertisement is further based on a type of the meeting.

4. The method of claim 1, wherein the determining a destination location includes receiving a search for a desired location and performing a search for the desired location.

5. The method of claim 4, wherein the generating at least one targeted advertisement is further based on the search for the desired location.

6. The method of claim 1, wherein the determining a starting/destination location includes determining an identification of the user remote mobile device and retrieving the starting/destination location corresponding to the user remote mobile device identification from a database of locations.

7. The method of claim 1, wherein the determining the destination location is based on a profile or database.

8. The method of claim 1, wherein the generating at least one targeted advertisement includes generating a targeted advertisement of a locale, event, and/or businesses in the area of the starting location, destination location, and/or en route based on the directions and based on demographics of people associated with the areas.

9. The method of claim 1, further comprising storing the request for directions in the corresponding user profile

10. The method of claim 1, wherein each user profile is associated with at least one user remote mobile device identification.

11. The method of claim 1, wherein the generating at least one targeted advertisement includes:
determining if the user is local or a visitor to the starting and/or destination locations based on at least one of an identification of the user remote mobile device and the user profile.

12. The method of claim 1, wherein the transmitting the directions and the at least one targeted advertisement is performed over a connection established via a 10-digit non-toll free mnemonic number.

13. A system for providing directions with targeted advertising, comprising:
a directions generating engine configured to generate directions from a starting location to a destination location received as a request for directions from a user, the directions being for transmission to a user remote mobile device; and
a targeted advertisement generating engine configured to generate advertisements for transmission to the user remote mobile device, the advertisements being generated based on at least one of the starting location, the destination location, the directions, a time associated with the directions, and/or a user profile associated with a user.

14. The system of claim 12, wherein the targeted advertisement generating engine is further configured to generate advertisements based on a type of meeting to which at least one third party invitee is invited by the user.

15. The system of claim 12, further comprising:
a user profiles database configured to store user profiles, each user profile being associated with at least one identification of a remote mobile device.

16. The system of claim 12, wherein the directions generating engine is further configured to determining a destination location by receiving a search for a desired location from the user and performing a search for the desired location.

17. The system of claim 16, wherein the targeted advertisement generating engine is further configured to generate advertisements based on the search for the desired location.

18. The system of claim 12, wherein the targeted advertisement generating engine is further configured to generate an advertisement of a popular locale, event, and/or businesses in the area of the starting location, destination location, and/or en route based on the directions and demographics of people associated with the areas.

19. The system of claim 12, wherein the directions generating engine is further configured to store the request for directions in the corresponding user profile

20. The system of claim 12, wherein each user profile is associated with at least one user remote mobile device identification.

21. The system of claim 12, wherein the targeted advertisement generating engine is further configured to generate advertisements based on whether if the user is local or a visitor to the starting and/or destination locations based on at least one of an identification of the user remote mobile device and the user profile and, if the user is a visitor, then generating at least one advertisement for tourist destination and/or other visitor sites.

22. The system of claim 12, wherein the system is accessible by the user by calling a 10-digit non-toll free mnemonic number via the user remote mobile device.

23. A method for accessing a service via a telephone network, comprising:
providing a telephone number, the telephone number being a 10-digit non-toll free mnemonic number.
